(19) United States
(12) Patent Application Publication
(10) Pub. No.: US 2008/0016440 A1
(43) Pub. Date: Jan. 17, 2008

(54) Programming And Managing Sensor Networks

(75) Inventors: Jie Liu, Sammamish, WA (US); Siddharth S. Seth, Maharashtra (IN); Alec LC Woo, Union City, CA (US); Feng Zhao, Issaquah, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/457,673

(22) Filed: Jul. 14, 2006

(51) Int. Cl. G06F 3/00

(52) U.S. Cl. 715/700

(57) ABSTRACT

Sensor nodes are programmed by representing a sensor node of a sensor network as a field on a displayed page, displaying a list of programs with which the sensor node can be programmed, and programming the sensor node in accordance with user selection of the field representing the at least one sensor node and a program from the list of programs. Also, a spreadsheet application can be configured to receive and display streaming sensor data from one or more sensor nodes of a sensor network.

### BACKGROUND

Sensor networks are often difficult to program, due to the inherently distributed nature of sensor networks, which may cross multiple tiers of computing platforms including sensors, gateways, and servers. In addition, the unpredictability of the physical phenomenon being monitored by the sensor network often requires multiple iterations of data analysis, algorithmic changes, and/or processing changes. These hurdles make programming sensor networks difficult and troublesome.

Additionally, collection and management of data from sensor networks is often cumbersome. The sensor data is typically stored in a database for subsequent retrieval, manipulation, or display. Collected data must be interpreted, processed, and formatted so as to be readable by a user. Previously, sensor data visualization and processing software has been highly domain specific, leaving users little flexibility for customization.

### SUMMARY

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

In view of the above, this disclosure describes ways of programming sensor nodes of sensor networks, and ways of managing streaming sensor data. In one aspect, sensor nodes can be programmed by representing a sensor node of a sensor network as a field on the displayed page, displaying a list of programs with which the sensor node can be programmed, and programming the sensor node in accordance with user selection of the field representing the sensor node and a program from the list of programs.

In another aspect, a spreadsheet application can be configured to receive data streams of streaming sensor data from one or more sensor nodes of a sensor network. The spreadsheet interface displays the streaming sensor data to a user on a spreadsheet. In this manner, streaming sensor data can be effectively and simply managed.

### BRIEF DESCRIPTION OF THE DRAWINGS

In the figures, the left-most digit of a reference number identifies the particular figure in which the designated component or act first appears.

FIG. 1 is a schematic diagram showing an exemplary sensor network having a three-tiered layout.

FIG. 2 is schematic diagram showing an exemplary sensor spatial deployment map.

FIG. 3 is a diagram showing an exemplary spreadsheet interface for programming sensor nodes of a sensor network.

FIG. 4 is a diagram showing an exemplary spreadsheet interface for programming sensor nodes of a sensor network, with the sensor nodes represented on the spreadsheet according to their spatial location.

FIG. 5 is a flow chart showing an exemplary method of programming sensor nodes of a sensor network.

FIG. 6 is a block diagram showing an exemplary system for streaming sensor data from a sensor network.

FIG. 7 is a diagram showing an exemplary spreadsheet interface for managing streaming sensor data from a sensor network, with sensor nodes represented on the spreadsheet according to their spatial location.

FIG. 8 is a diagram showing an exemplary spreadsheet interface with real-time data streams from two sensor nodes of FIG. 7.

FIG. 9 is a diagram showing another exemplary spreadsheet interface for managing streaming sensor data from a sensor network, with sensor nodes represented on the spreadsheet according to their spatial location.

FIG. 10 is an exemplary method of managing streaming sensor data using a spreadsheet interface.

### DETAILED DESCRIPTION

### Overview

This disclosure is directed to programming and management of sensor networks using an application program to provide a simple user experience for interacting with sensor networks, in terms of both programming, and data management. In the exemplary implementations described herein, the application program is a spreadsheet application, which uses a spreadsheet as an interface to program sensor nodes and manage sensor networks. However, it should be understood that various other types of application programs could alternatively or additionally be used, and could employ various different interfaces, such as a database, a word processing document, an extensible markup language (XML) document, combinations thereof, and the like.

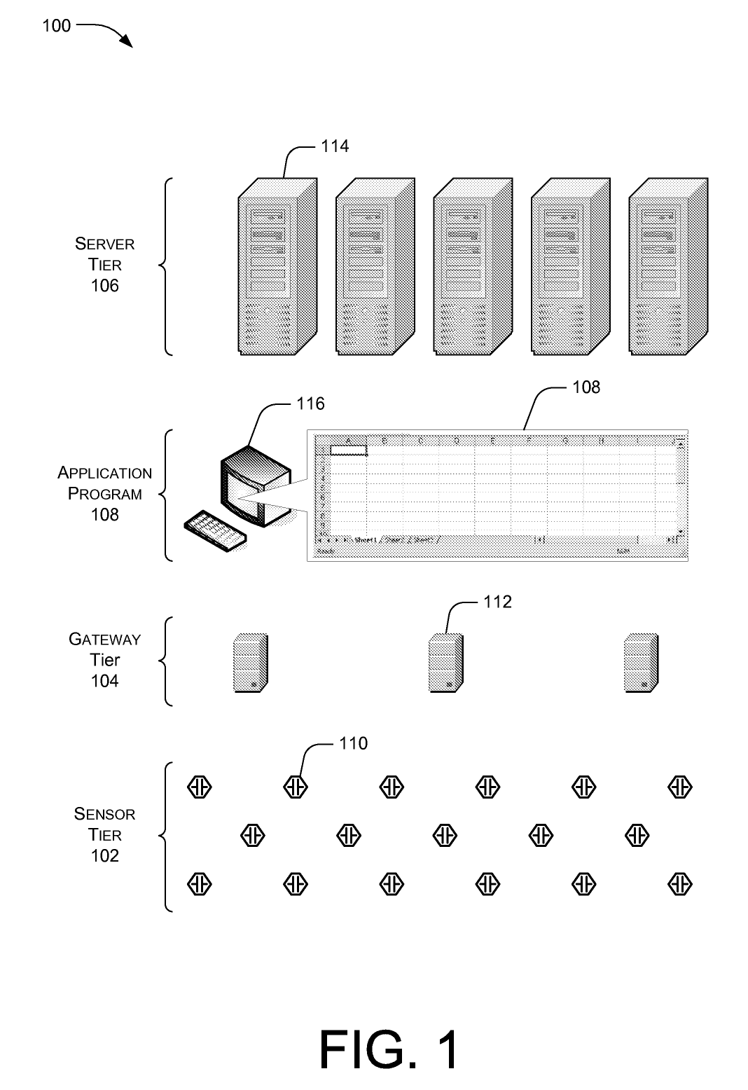

FIG. 1 is a schematic diagram showing an architectural overview of an exemplary sensor network 100 usable in, for example, data collection, environmental monitoring, and event detection applications. The sensor network 100 generally has a three-tiered layout, including a sensor tier 102, a gateway tier 104, and a server tier 106. An application program 108 provides a user interface for user interaction with the sensor network 100.

The sensor tier 102 shown at the bottom of FIG. 1 comprises one or more sensor nodes 110 (sometimes referred to as motes) deployed over a field. Each sensor node 110 may in turn include one or more sensors. The sensor tier 102 may include any number and type of sensors. By way of example and not limitation, several general types of sensors that may make up the sensor network include environmental sensors, physical event detection and/or monitoring sensors, electrical sensors, optical sensors, mechanical sensors, and the like. However, it should be understood that sensor networks may include any other known sensors, depending on the data to be monitored or collected or other considerations.

The gateway tier 104 comprises one or more gateways 112 (sometimes referred to as gateway nodes or microservers). The sensor nodes 110 are organized into a single or multiple-hop network, streaming data towards the gateways 112, the middle tier of sensor network 100. The gateways 112 may be wireless or wired, but typically will have higher link bandwidth and better reliability than the individual sensor nodes 110. The gateways 112 can be programmed, as discussed further below, to process the data streams or even to operate as delegates for querying the sensor tier 102. The gateways 112, as their name suggests, also act as an entry point to the rest of the network (e.g., Internet, wide area network (WAN), or local area network (LAN)) for the sensor nodes 110.

The sever tier 106 comprises one or more servers 114, databases, and/or other storage and/or processing devices. Typically, devices on the server tier 106 are more powerful than the microserver gateways 112, though not necessarily. Data streams from the gateways 112 can be aggregated and archived for further processing by the servers 114 or other devices in the server tier 106. The server tier 106 at the top of FIG. 1 supports an Internet-scale sensor system. Of course, smaller scale networks may also be supported by the server tier 106.

Programming and managing each of the tiers using conventional programming and management techniques is difficult and cumbersome, not to mention trying to integrate the various devices in each tier together to form a complete system. The application program 108 provides a simple interface so that users can visualize the data relationships from different perspectives.

The application program 108 provides a user interface for programming devices on the sensor network 100 and for managing and organizing collected sensor data. The application program 108 is shown in FIG. 1 being accessed on a user terminal 116. However, it should be understood that the application program 108 could be located anywhere on the network and accessed locally or remotely. Also, processing may be distributed for scalability reasons with appropriate run-time support. To preserve the distributed nature of the system, data processing within the application program 108 can fall back to servers 114, gateways 112, or even sensor nodes 110.

In the exemplary implementations described herein, the application program 108 is described in the context of a spreadsheet application. However, the application program may additionally or alternatively comprise a database application, word processing application, XML-based application, or any other suitable application program. If the application program 108 is based on a spreadsheet, the same built-in statistical functions and data visualization tools of the spreadsheet can be used for analyzing data streams in the sensor network context. Also, the ease of integrating a spreadsheet with web services and databases at the server tier 106 makes the spreadsheet a very convenient tool.

Such a spreadsheet model facilitates combining streaming real-time data with static information such as node locations, configurations, and non-sensor related information. For example, as discussed in more detail with respect to the exemplary implementations below, a sensor deployment map can be overlaid on a spreadsheet, so that cells representing sensor nodes are positioned on the spreadsheet according to the sensor node locations on the deployment map. This allows users to both manage the node and its data stream like manipulating individual cells on a spreadsheet. Changing the values in the cell corresponding to a node can automatically configure or even reprogram the node.

### Exemplary Sensor Network

In one exemplary implementation, the sensor nodes 110 comprise Tmote sky sensor nodes, available from Moteiv Corporation of San Francisco, Calif., the gateways 112 comprise personal computer (PC) gateways with μSEE microserver run-time, available from Microsoft Corporation of Redmond, Wash., the servers 114 comprise structured query language (SQL) servers, also available from Microsoft Corporation, and the user terminal 116 comprises a PC loaded with Microsoft Visual Studio™, also available from Microsoft Corporation.

In this implementation, the application program 108 comprises a spreadsheet application, which incorporates and expands on Microsoft Excel™ spreadsheet application to include the ability to program the sensor network and to manage and organize streaming sensor data in real-time. In this implementation, Microsoft Excel™ is built on top of a service-oriented abstraction architecture provided by the μSEE microserver run-time. Although there are other ways to interface Microsoft Excel™ with sensor networks, this service-oriented abstraction layer and the XML Web Service interface it provides are flexible, extensible, and easy to work with. Using Microsoft Excel™ with its built-in visual basic for applications (VBA) scripting capability provides a user interface that eases the process of programming (i.e., downloading code to) the sensor tier.

### Exemplary Spreadsheet Interface for Programming Sensor Nodes

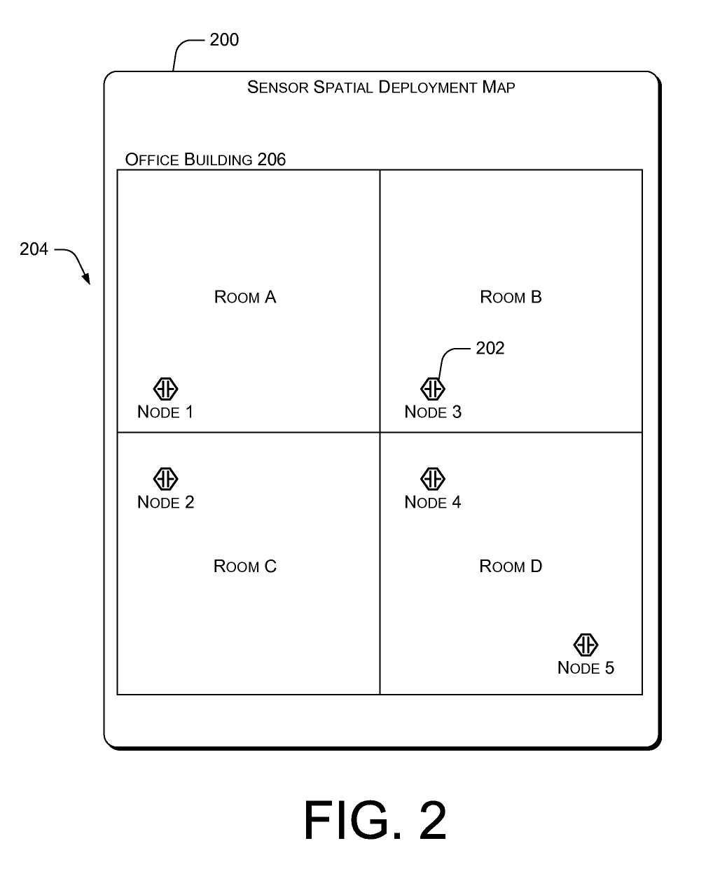

The functionality and operation of an exemplary spreadsheet interface for programming sensor nodes and managing streaming sensor data is described below with respect to FIGS. 2-5.

FIG. 2 is an exemplary spatial deployment map 200 showing the spatial locations of sensor nodes 202 of a small, five-node sensor network 204 in a four-room office building. As shown on the spatial deployment map 200, sensor nodes 202 of the sensor network 204 are located as follows:

Node 1—lower left corner of Room A,

Node 2—upper left corner of Room C,

Node 3—lower left corner of Room B,

Node 4—upper left corner of Room D, and

Node 5—lower right corner of Room D.

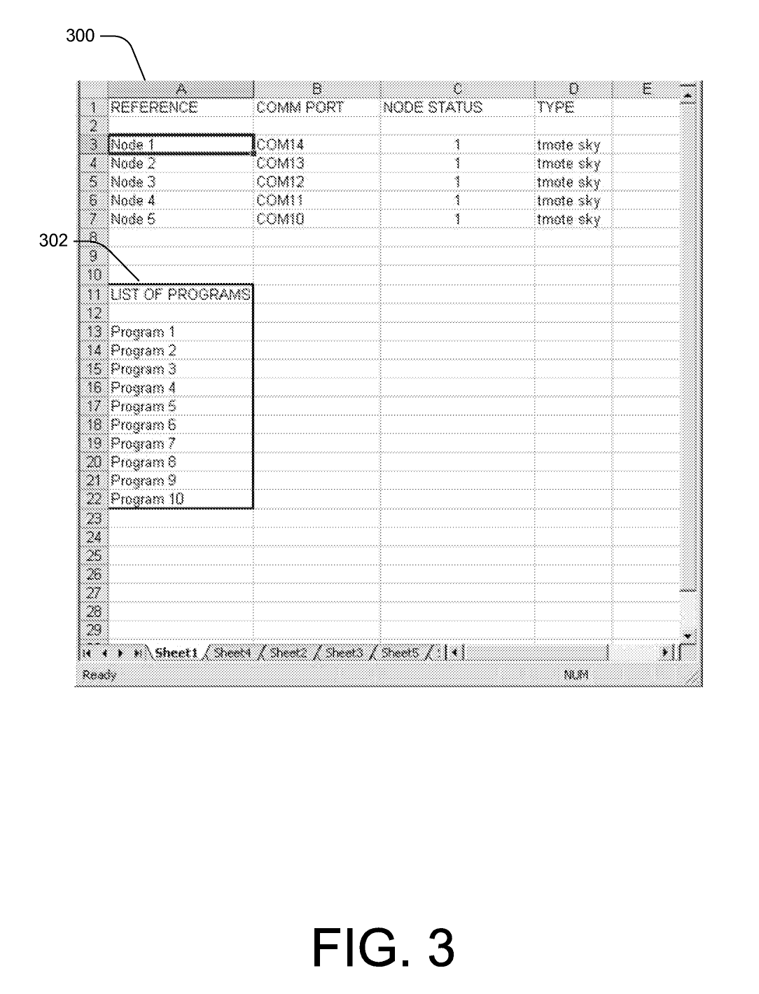

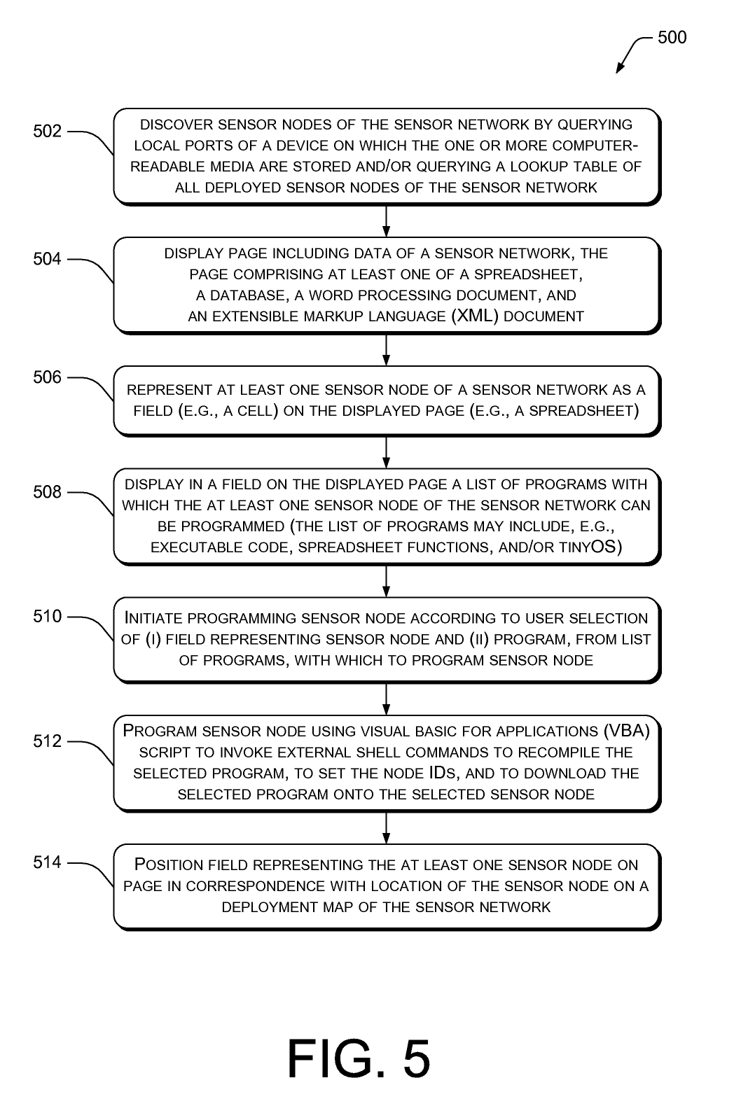

FIG. 3 is a diagram showing an exemplary spreadsheet interface 300 for programming sensor nodes of a sensor network. The spreadsheet interface is described in the context of programming the sensor network 204 of FIG. 2. Before programming the sensor nodes, the application program must discover the deployed sensor nodes 202 connected to the sensor network 204, as described in more detail below with reference to the method of FIG. 5. In one implementation, this is done by sending a pinging message to the sensor node, which will send a responding message if the node is working properly. Once node discovery is done, each sensor node 202 is represented as a cell on the spreadsheet 300. In the example of FIG. 2, the sensor network 204 has five sensor nodes, Nodes 1-5, which are represented in cells A3-A10, respectively, of the spreadsheet 300 in FIG. 3. Columns B, C, and D of the spreadsheet may be configured to display additional information about the sensor nodes, such as the address (COMM PORT) at which the sensor node can be reached, the node status (a 1 in the node status column indicates that the sensor node is alive, otherwise the node status will be 0), the type of sensor node (in this case Tmote sky), or any other desired information about the sensor node.

A user may select a sensor node to program by selecting the corresponding cell on the spreadsheet 300. A list of programs 302 with which the selected sensor node can be programmed will be displayed. The list of programs 302 may be displayed in cells of the spreadsheet 300, as shown in FIG. 3. Alternatively, the list of programs 302 may be displayed as an embedded object within the spreadsheet 300, as a drop-down file menu of the application program, as an open file dialog box that allows users to browse files on the disk, as a list in a separate window entirely, or in any other suitable manner. The list of programs may include TinyOS applications, spreadsheet functions (e.g., mathematical functions, relationships, data analysis functions, etc.), or any other software that is executable on the sensor node.

Once the sensor node(s) and the desired program(s) have been selected, the code of the program(s) can be sent to the sensor node(s) by, for example, universal serial bus (USB), Ethernet, wireless, or any other suitable connection. The VBA script of the spreadsheet application will invoke external shell commands to recompile the program(s), if necessary, set the node IDs for the selected sensor node(s), if necessary, and download the program(s) to the selected sensor node(s).

Thus, to program sensor Node 1 with Program 4, a user would simply select cell A3 (representing Node 1) and cell A20 (representing Program 4). The spreadsheet program would then download Program 4 to Node 1.

In some instances it may be difficult to keep track of where each sensor node is located in the field, particularly where there are numerous sensor nodes distributed over different locations. To help users visualize the location of the various sensor nodes, it may be desirable to position the spreadsheet cells representing the sensor nodes according to the position of the corresponding sensor nodes in the field. This can be done by formatting the spreadsheet to correspond to a spatial deployment map of the sensor network.

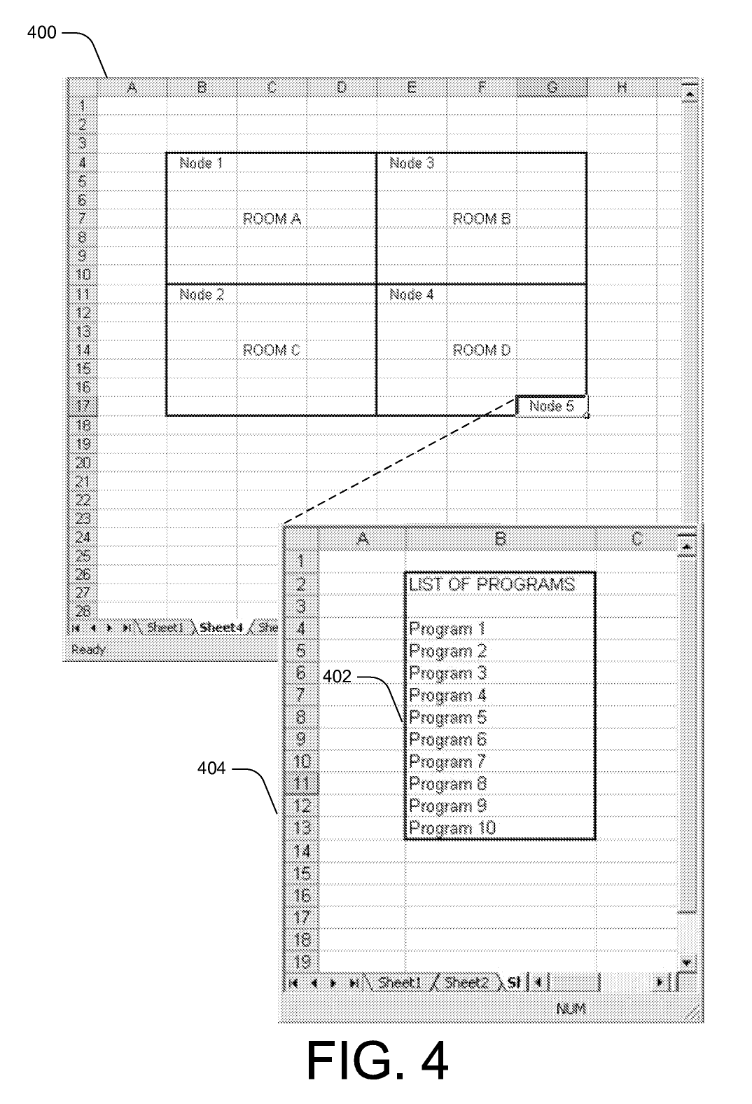

FIG. 4 is a diagram showing an exemplary spreadsheet interface for programming sensor nodes of a sensor network, with the sensor nodes represented on a spreadsheet 400 according to their spatial location. The spreadsheet interface of this implementation is described in the context of the spatial deployment map of FIG. 2. As shown in FIG. 4, the spreadsheet 400 includes cells B4, B11, E4, E11, and G17, representing Nodes 1-5, respectively, of sensor network 204. To help a user visualize the location of the sensor nodes, the cells are positioned on the spreadsheet 400 at locations corresponding to the spatial locations of Nodes 1-5 on the spatial deployment map of FIG. 2.

When a user selects a cell corresponding to one of the sensor nodes, a list of programs 402 with which the sensor node can be programmed is displayed. The list of programs 402 may be displayed in a separate window 404, as shown in FIG. 4, or in cells of the spreadsheet, generally as shown in FIG. 3. Alternatively, the list of programs 402 may be displayed as an embedded object within the spreadsheet 400, as a drop-down file menu of the application program, or in any other suitable manner. The list of programs may include TinyOS applications, spreadsheet functions (e.g., mathematical functions, relationships, data analysis functions, etc.), or any other executable code.

### Exemplary Method of Programming Sensor Nodes

FIG. 5 is a flow chart showing an exemplary method 500 of programming sensor nodes of a sensor network using an application program. The method may, but need not necessarily, be implemented using a spreadsheet interface, such as those shown in FIGS. 3 and 4.

Generally, prior to programming sensor nodes, the method 500 includes, at 502, discovering the sensor nodes connected to the sensor network. For sensor nodes connected directly to a USB, serial, or other port of the device on which the application program is stored, discovery simply means querying to see which local ports have sensor nodes attached. This may be done by invoking corresponding TinyOS tools designed for wireless embedded sensor networks, such as “Motelist,” which is a command-line utility that displays which serial ports have Tmote motes attached. For sensor nodes connected to the sensor network via an Ethernet or other network, discovery often means going through a lookup table that contains information of all deployed sensor nodes. If nodes are deployed in a multi-hop mesh (e.g., via one or more gateways), node discovery may be facilitated by sensor network management system software. To make sure that the nodes are alive, the software sends a short packet to the sensor nodes and waits for them to reply.

Once the sensor nodes connected to the sensor network have been discovered, or are otherwise known to the application program, data of the sensor network are displayed, at 504, on a page of the application program. The page may be a spreadsheet, a database, a word processing document, and/or an extensible markup language (XML) document.

At 506, sensor nodes of the sensor network are represented on the page as a field (e.g., a cell) on the displayed page (e.g., a spreadsheet). A list of programs with which the sensor node can be programmed is displayed, at 508, in a field (e.g., one or more cells) on the displayed page, in a separate window, in a drop-down file menu, or in any other suitable display. The list of programs may include executable code, spreadsheet functions, and/or tinyOS, for example.

Programming of one or more sensor nodes is initiated, at 510, in accordance with user selection of (i) a field representing the sensor node(s) and (ii) one or more programs, from the list of programs, with which to program the sensor node(s). At 512, the sensor node(s) are programmed using visual basic for applications (VBA) script to invoke external shell commands to recompile the selected program, set the node IDs, and download the selected program onto the selected sensor node.

At 514, the field representing the at least one sensor node is positioned on the page in correspondence with location of the sensor node on a deployment map of the sensor network, as shown in FIG. 4.

It should be understood that certain acts in method 500 need not be performed in the order described, may be modified and/or may be omitted entirely, depending on the circumstances. For example, sensor nodes need not necessarily be discovered if they have previously been discovered, if their existence and locations are entered manually by a users or if such information is otherwise already known. Also for example, the fields representing the sensor nodes need not necessarily be positioned in accordance with the location of the sensor nodes on a spatial deployment map. Instead, the fields may be positioned in any other suitable configuration, such numerical order, alphabetical order, temporal order of connection to the sensor network, or the like.

Moreover, any of the acts described above may be implemented by a processor or other computing device based on instructions stored on one or more computer-readable media associated with the application program and/or sensor network. Computer-readable media can be any available media that can be accessed by the application program and/or the sensor network. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the application program and/or the sensor network. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

### Exemplary System for Streaming Sensor Data

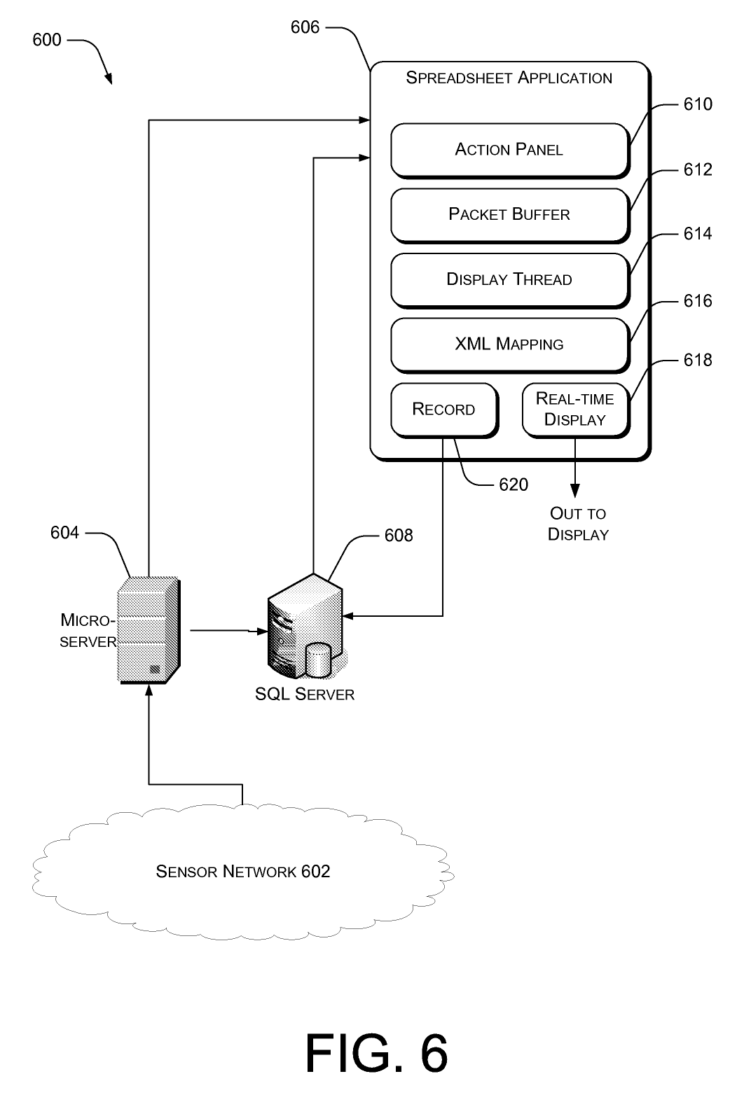

FIG. 6 is a block diagram showing an exemplary system 600 for streaming sensor data from a sensor network 602. Sensor nodes connected to the sensor network 602 communicate with microserver gateways 604 (only one is shown, but the system may include any number of gateways to aggregate data streams from the sensor network 602), which feed data into a spreadsheet application 606. The spreadsheet application 606 may be resident on a user terminal (not shown) or elsewhere on the network. The spreadsheet application, in this implementation is a modified version of Microsoft Excel™, which has been extended, using Microsoft Visual Studio™ 2005 with .NET 2.0, to act as an agent to query the gateway 604 for incoming streaming sensor data. Data streams may also be fed by the gateways 604 to one or more SQL servers 608 or other data storage devices for storage and later retrieval. Only one SQL server 608 is shown, but any number of SQL servers or other data storage devices may be used and may be located anywhere on the network.

The gateways 604 run a service-oriented microserver called μSEE. The μSEE microservers provide a service abstraction over the gateway and sensor tiers. An XML script called micro-server tasking markup language (MSTML) is used to configure the functionality of the microserver gateway. This configuration may include specifying how the microserver gateway should convert raw sensor data into application independent representations such as XML. This configuration can be predefined or done within the spreadsheet application 606.

In this example, the microservers use XML as a configuration language to glue loosely coupled computational components (called services) into a workflow (called service composition). The service composition automatically converts data streams from the platform-dependent sensor data format of the sensor tier, into platform-independent XML streams for transmission to the spreadsheet application 606.

The spreadsheet application 606 includes an action panel 610, by which a user can select data sources of the network, including real-time data from the sensor network 602 and/or archived data from the SQL server 608. The streams of data are first queued by a packet controller in a packet buffer 612. A separate display thread 614 periodically takes data out from the buffer 612 and concatenates multiple packets into a data view using XSL transformations. The display thread 614 also assigns each data stream a unique namespace. The view is then output via a display output 618 and mapped to cells of a spreadsheet page using the XML mapping feature 616 of the spreadsheet application 606. That is, the schema for this XML stream is mapped to cells of a spreadsheet using the XML mapping feature 616. XML mapping is a process of dragging and dropping a particular element from an XML schema onto a spreadsheet cell, which informs the spreadsheet application 606 to bind data associated with that element to the cell upon loading future data. Thus, each element to be mapped should be unique in the XML map definition. Accordingly, the data for each data stream is represented as a unique namespace.

The spreadsheet application 606 also includes a record output 620, which allows the spreadsheet application to send data to one or more storage devices, such as the SQL server 608 for later retrieval.

The usage of this spreadsheet application 606 requires no special knowledge of the packet stream or of XML maps. The user only needs to load the spreadsheet and define the XML maps to use by loading a network configuration file, which automatically creates the necessary extensible stylesheet language (XSL) transformations for the data streams. Then, the user would utilize the XML maps feature of the spreadsheet to drag elements from the list to the appropriate cell where they would like to bind the data. For any elements that have an unbounded size attribute, the spreadsheet will automatically grow lists when new data is added to the document.

Once the maps are defined, a data connection is created using the action panel 610 by specifying either a real-time connection to the gateway 604 or to the SQL Server 608 for previously recorded data. Once data streams are mapped onto the spreadsheet lists, processing the data may be done in the same manner as for a traditional spreadsheet, since the spreadsheet application may include all of the formulas, formatting, plotting, analysis tools, and the like available on a conventional spreadsheet application.

If the spreadsheet has an event-driven model of computation built-in, whenever the value of a cell changes, all dependent formulas and plots will be reevaluated and refreshed automatically. This allows users to always have the most recent view of the processing results without managing data propagation manually.

### Exemplary Spreadsheet Interface for Managing Streaming Sensor Data

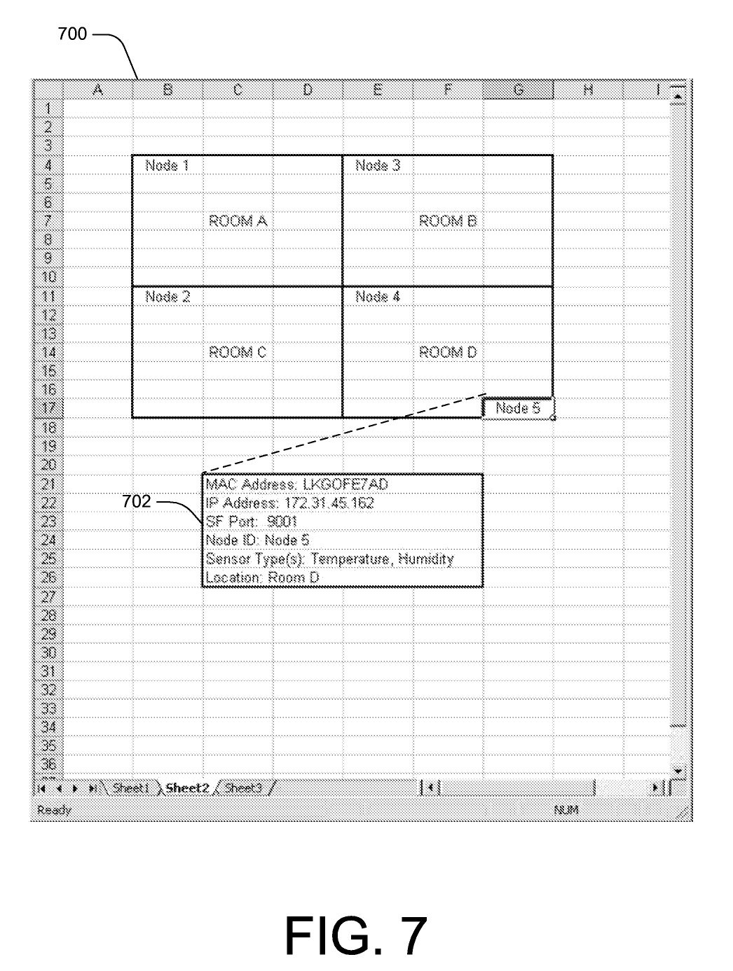

FIG. 7 is a diagram showing an exemplary spreadsheet interface for managing streaming sensor data from a sensor network, with sensor nodes represented on a spreadsheet 700 according to their spatial location. The spreadsheet interface of this implementation is also described in the context of the spatial deployment map of FIG. 2. In this implementation, the nodes are used to collect environmental data within a typical office building. The sensor nodes are capable of sensing ambient light, photosynthetic light, temperature, and humidity, and are deployed across four offices (Rooms A-D) of an office building, as shown in FIG. 2.

As shown in FIG. 7, the spreadsheet 700 includes cells B4, B11, E4, E11, and G17, representing Nodes 1-5, respectively, of sensor network 204. To help a user visualize the location of the sensor nodes, the cells are positioned on the spreadsheet 700 at locations corresponding to the spatial locations of Nodes 1-5 on the spatial deployment map of FIG. 2.

Deployment specific information of each node can be described using XML and stored as cell values in the spreadsheet 700. The information may include node ID, types of sensors on the node, and location of the node, among other things. When a user selects a cell representing one of the sensor nodes, an information table 702 is displayed, which includes information about the node, such as media access control (MAC) address, internet protocol (IP) address, serial forwarder (SF) port, node ID, types of sensors on the node, and location of the node. Additional information, such as Host, program (Prog) Port, and Mote Serial, and the like may also be provided.

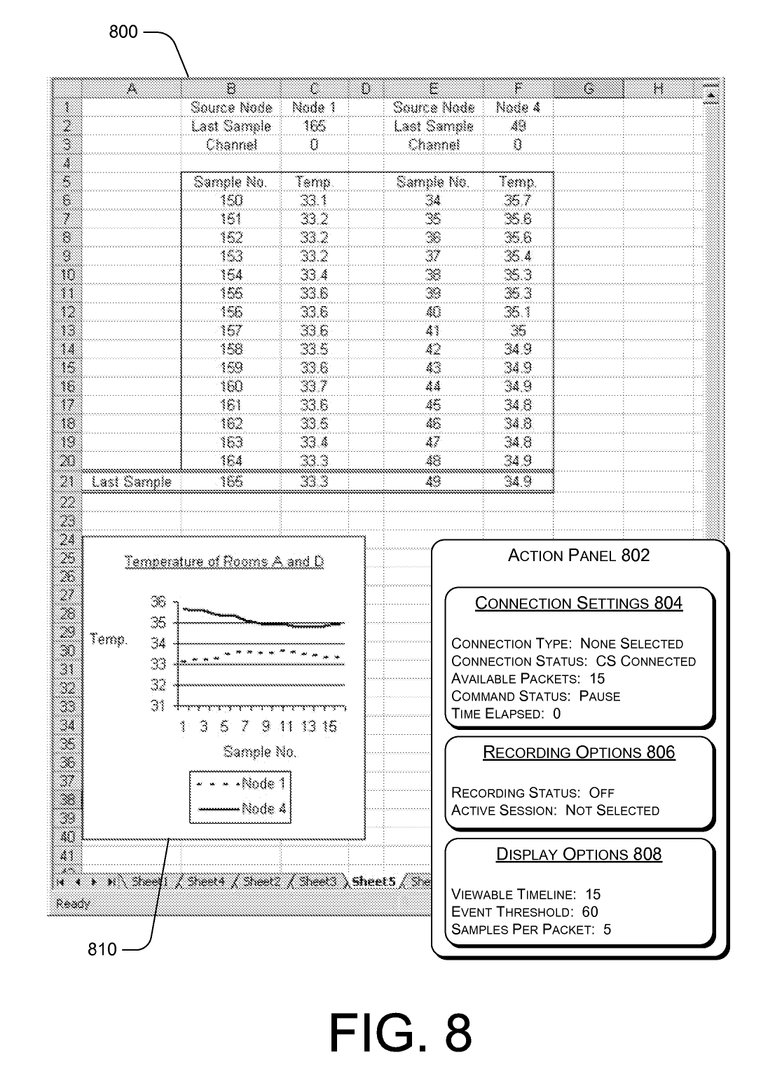

To visualize and process the sensor data streams from the sensor nodes, users can select to display sensor data for one or more of the sensors discovered and shown on the spreadsheet 700. The user can simply select the cells corresponding to the desired sensor nodes to subscribe to their data streams. The selected data streams will be shown automatically on a different worksheet, such as that shown in FIG. 8, described below. Alternatively, the data streams can be shown in cells of the same worksheet, or in an embedded object in the same or different worksheet.

The spreadsheet application can automatically infer the schema of incoming XML objects and display them on the spreadsheet 700, if desired. Alternatively, users may layout and select important fields from the XML data streams manually.

FIG. 8 is a diagram showing an exemplary spreadsheet interface, displaying real-time data streams from sensor Nodes 1 and 4 of FIG. 7 on a spreadsheet 800. The spreadsheet interface includes an action panel 802 having a connection settings interface 804 for controlling the connection with the sensor network, a recording options interface 806 for controlling whether to record the selected data streams, and a display options interface 808 for controlling how the selected data streams are displayed on the spreadsheet 800.

The display options interface 808 allows a user to set the Viewable Timeline (in number of packets) that are displayed. This is the total number of packets (or data points) that are to be displayed on the spreadsheet 800 at one time. In FIG. 8, the Viewable Timeline interface is set to 15. By default, the most recent sample is displayed at the bottom of the data stream (i.e., in cells C21 and F21 in FIG. 8). When input streams are longer than the specified number N of packets in the Viewable Timeline, only the last N packets are displayed.

The user can also set the Event Threshold (in number of packets), which is the refresh rate of the spreadsheet interface 800. That is, only when the number of un-displayed input packets exceeds this number, will the spreadsheet application load the packet (in batch) and update the spreadsheet interface 800. The user can also set the number of Samples Per Packet. This allows a user to set a downsampling factor if the user does not wish to display all samples due to scalability concerns. In this manner, the user sees only a subset of the samples.

In this case, Nodes 1 and 4 are configured to measure temperature. Since the Viewable Timeline of the action panel 802 has been set to 15, the last 15 data points are displayed on the spreadsheet 800 in cells C6-C21 (for Node 1) and cells E6-E21 (for Node 4). The displayed temperature values may correspond to the raw sensor data, but in this case have been converted using conventional spreadsheet functions into Celsius values which are more useful to the user.

The sensor data may be plotted using the spreadsheet's standard plotting function, to generate a real-time graph 810 of the data streams to help visualize the relationship of the data streams. In addition, users can use the deployment specific information layout in FIG. 7 to visualize the spatial distribution of the data.

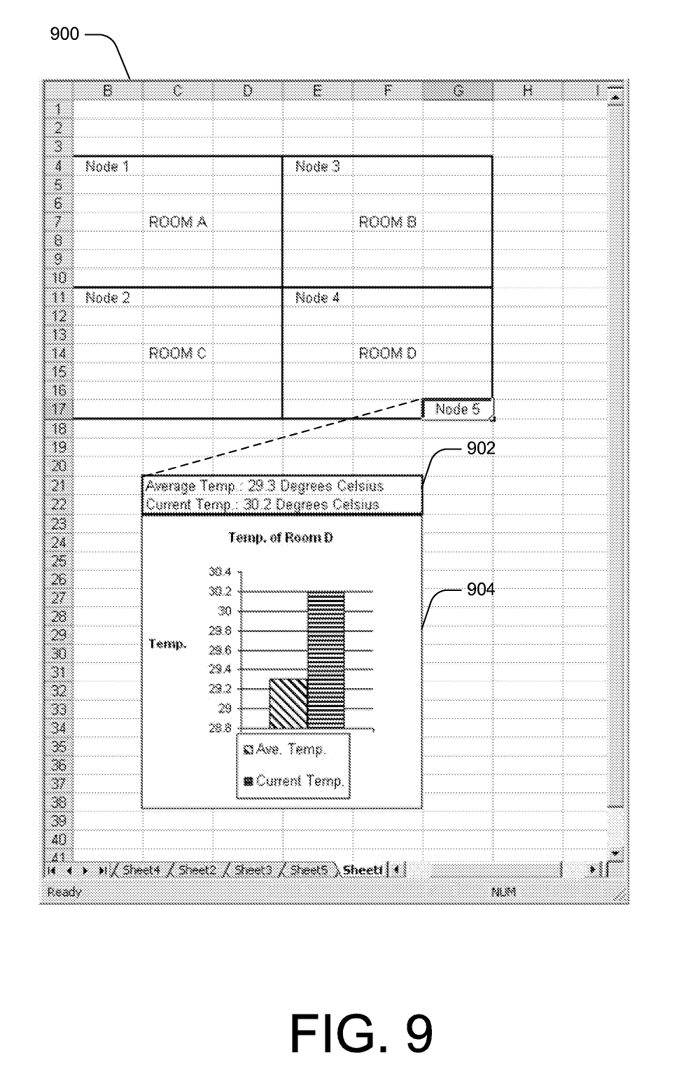

FIG. 9 is a diagram showing another exemplary spreadsheet interface for managing streaming sensor data from a sensor network, with sensor nodes represented on a spreadsheet 900 according to their spatial location. Clicking on a cell corresponding to a node will display a callout box 902, showing details of the data stream from that sensor node. In this case, the cell corresponding to Node 5 is selected. Node 5 measures temperature and the callout box, therefore, displays the average temperature and the current temperature measured by Node 5 in degrees Celsius. The data in this view can also be plotted in a graph 904 of the sensor node output that is adjusted dynamically, depending on real-time data. While the callout box 902 and graph 904 are shown as being displayed on cells of the spreadsheet 900, they could instead be displayed as objects within the spreadsheet 900 or in a separate window, or in any other suitable configuration.

### Exemplary Method of Displaying Streaming Sensor Data

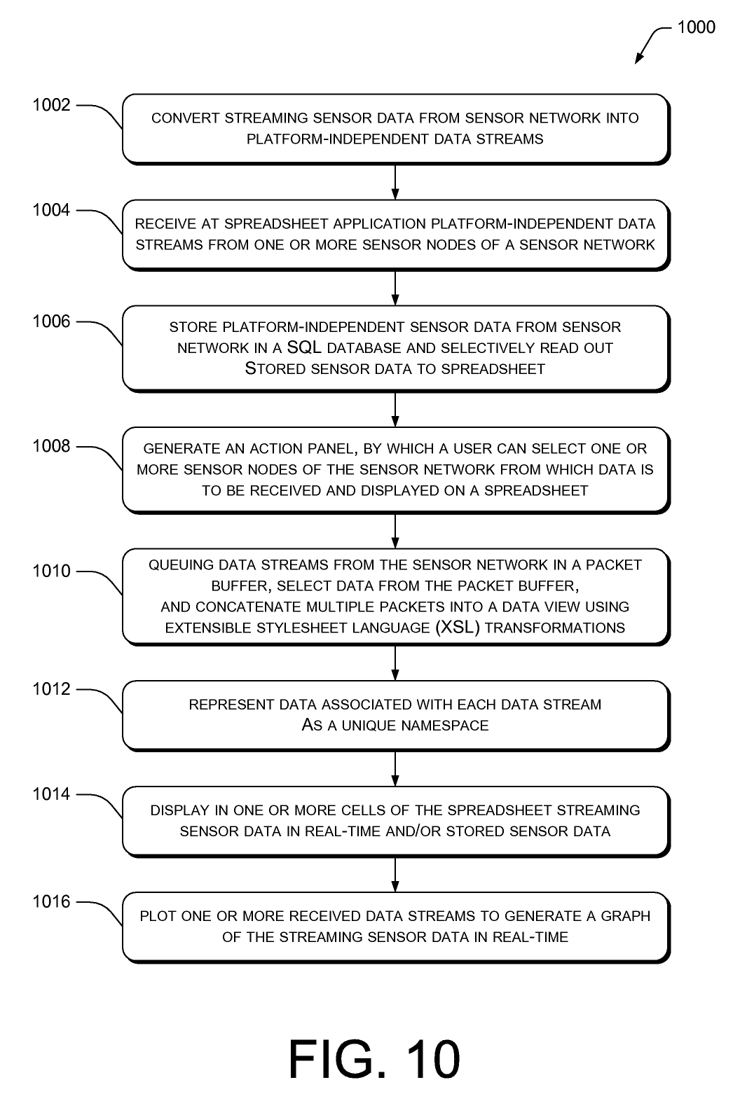

FIG. 10 is a flow chart showing an exemplary method 1000 of displaying streaming sensor data using a spreadsheet interface. The method may, but need not necessarily, be implemented using a spreadsheet interface, such as those shown in FIGS. 7-9.

Generally, prior to displaying sensor data on a spreadsheet, the streaming sensor data from the sensor network is converted, at 1002, from device-dependent sensor data into platform-independent data streams. At 1004 the platform-independent data streams from the sensor nodes of the sensor network are received at the application program. Additionally or alternatively, at 1006, platform-independent sensor data from the sensor network may be stored in an SQL database or other storage device, to be selectively read out to the spreadsheet application at a later date.

The application program may include an action panel, by which a user can select one or more sensor nodes of the sensor network and/or stored sensor data from the SQL database, from which to receive data. In that case, at 1008, the action panel is generated, and a user can select the desired data streams from the sensor nodes and/or stored sensor data from the SQL database to be received and displayed on the spreadsheet.

At 1010, the data streams are queued from the sensor network in a packet buffer, data from the packet buffer are selected, and multiple packets are concatenated into a data view using XSL transformations. At 1012, data associated with each data stream is represented as a unique namespace.

Streaming sensor data and/or stored sensor data is displayed at 1014 in one or more cells of the spreadsheet in real-time. The received data streams may be plotted at 1016 to generate a graph of the streaming sensor data in real-time.

It should be understood that certain acts in method 1000 need not be performed in the order described, may be modified and/or may be omitted entirely, depending on the circumstances. For example, data need not necessarily be stored in an SQL database or other storage device. Also for example, instead of the action panel, various other user interfaces could be used to manage the data streams. Additionally, the data need not necessarily be plotted to generate a real-time graph.

Moreover, any of the acts described above may be implemented by a processor or other computing device based on instructions stored on one or more computer-readable media associated with the application program and/or sensor network.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims. For example, the methodological acts need not be performed in the order or combinations described herein, and may be performed in any combination of one or more acts.

What is claimed is:

1. One or more computer-readable media comprising instructions for:
displaying a page including data of a sensor network;
representing at least one sensor node of a sensor network as a field on the displayed page;
displaying a list of programs with which the at least one sensor node of the sensor network can be programmed; and
programming the at least one sensor node in accordance with user selection of (i) the field representing the at least one sensor node and (ii) a program, from the list of programs, with which to program the at least one sensor node.

2. The one or more computer-readable media of claim 1, wherein the displayed page comprises at least one of a spreadsheet, a database, a word processing document, and an extensible markup language (XML) document.

3. The one or more computer-readable media of claim 1, wherein the displayed page comprises a spreadsheet and the field comprises a cell of the spreadsheet, such that the at least one sensor node is represented as a cell of the spreadsheet.

4. The one or more computer-readable media of claim 1, wherein the list of programs with which the at least one sensor node of the sensor network can be programmed includes at least one spreadsheet function.

5. The one or more computer-readable media of claim 1, wherein the list of programs with which the at least one sensor node of the sensor network can be programmed includes at least one operating system.

6. The one or more computer-readable media of claim 1, further comprising instructions for positioning the field representing the at least one sensor node on the page in correspondence with a location of the at least one sensor node on a deployment map of the sensor network.

7. The one or more computer-readable media of claim 1, further comprising instructions for, prior to representing the at least one sensor node on the page, discovering sensor nodes of the sensor network.

8. The one or more computer-readable media of claim 7, wherein the instructions for discovering the sensor nodes comprise instructions for querying local ports of a device on which the one or more computer-readable media are stored.

9. The one or more computer-readable media of claim 7, wherein the instructions for discovering the sensor nodes comprise instructions for querying a lookup table of all deployed sensor nodes of the sensor network.

10. The one or more computer-readable media of claim 1, wherein the instructions for programming the at least one sensor node comprise visual basic for applications (VBA) script.

11. A system comprising:
a sensor network having at least one sensor node for collecting data; and
a user terminal in communication with the sensor network, the user terminal comprising a spreadsheet application usable to program sensor nodes of the sensor network.

12. The system of claim 11, further comprising at least one gateway interposed in the system between the sensor network and the user terminal, the gateway routing communications between sensor nodes of the sensor network and the spreadsheet application of the user terminal.

13. The system of claim 11, the spreadsheet application comprising a cell representing the at least one sensor node of the sensor network.

14. The system of claim 11, the spreadsheet application comprising a list of programs with which the at least one sensor node of the sensor network can be programmed.

15. The system of claim 11, the spreadsheet application comprising a cell representing the at least one sensor node of the sensor network, and a list of programs with which the at least one sensor node of the sensor network can be programmed, such that the at least one sensor node can be programmed by selection of the cell and a program from the list of programs.

16. A method comprising programming a sensor node using a spreadsheet application, comprising:
representing sensor nodes of a sensor network as cells on a spreadsheet;
displaying a list of programs with which sensor nodes of the sensor network can be programmed; and
sending a program from the list of programs to a sensor node, in response to selection of the program and the sensor node.

17. The method of claim 16, wherein the list of programs with which the sensor nodes of the sensor network can be programmed includes at least one spreadsheet function.

18. The method of claim 16, wherein the plurality of cells representing sensor nodes is positioned on the page in correspondence with location of the sensor nodes on a deployment map of the sensor network.

19. The method of claim 16, wherein displaying the list of programs with which sensor nodes of the sensor network can be programmed comprises displaying each program in a cell of the spreadsheet.

20. The method of claim 16, further comprising, prior to representing the sensor nodes on the spreadsheet, discovering sensor nodes of the sensor network by (i) querying local ports of a device on which spreadsheet application is stored, (ii) querying an external device that serves as a gateway or a proxy for at least one sensor, or (iii) querying a lookup table of all deployed sensor nodes of the sensor network.
